(19) United States
(12) Patent Application Publication
(10) Pub. No.: US 2004/0158859 A1
(43) Pub. Date: Aug. 12, 2004

(54) Digital television receiver and GUI changing method for digital television receiver

(75) Inventors: Keiichi Aoyama, Tokyo (JP); Shigeki Mori, Saitama (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/731,509

(22) Filed: Dec. 10, 2003

(30) Foreign Application Priority Data
Dec. 13, 2002 (JP) 2002-362986(PAT.)

(51) Int. Cl. G06F 13/00

(52) U.S. Cl. 725/45

(57) ABSTRACT

Provided are a digital television receiver in which a user on a digital television receiver side selects a program from among programs for changing an operation screen, which have undergone push-type distribution by being superposed on a broadcast wave, making it possible to customize a GUI by a simple operation, and a GUI changing method for the digital television receiver. The digital television receiver of the present invention includes: a television picture signal; a receiving unit for receiving a program for changing a GUI; an installing unit for selectively installing the program received by the receiving means; and a changing unit for executing the installed program to change the GUI.

### BACKGROUND OF THE INVENTION

1. Field of the Invention

The present invention relates to a digital television receiver for receiving television picture signals and a method of changing a graphical user interface (hereinafter, referred to as “GUI”) used for the digital television receiver.

2. Related Background Art

Up to now, operation screens for computer equipment can be changed in GUI by a user for the ease of use according to his/her purpose by changing decorative information (such as an appearance and a skin), changing an operation form (changing a chrome registry or an operation device), creating a set of aliases (such as links and shortcuts) of operation items (using a launcher etc.), or the like.

Also, patches and software necessary for various changes can be obtained by being searched for through the Internet, being downloaded therefrom, and being installed into a system of the computer system.

However, in the case of a digital television system, it requires difficult operations for a user to customize a menu screen by searching through the Internet for the patches and software and downloading them.

It is also unpreferable that wide-ranging users of the digital television system perform customization of its operation screens, while the customization of operation screens is usually performed on the computer equipment by the users who are relatively accustomed to the customization operation.

### SUMMARY OF THE INVENTION

It is an object of the present invention to provide a digital television receiver in which a user on a digital television side selects a program from among programs for changing an operation screen of a digital television system, which have undergone push-type distribution by being superposed on a broadcast wave, making it possible to customize a GUI by a simple operation, and also provide a GUI changing method for the digital television receiver.

The gist of the present invention also resides in a digital television receiver, including:

a television picture signal;

receiving means for receiving a program for changing a GUI;

installing means for selectively installing the program received by the receiving means; and

changing means for executing the installed program to change the GUI.

The installing means may preferably determine whether to install the program received by the receiving means based on an instruction by a user.

The digital television receiver may further include display means for displaying a menu screen.

The digital television receiver may further include storage means for storing user's preference information,

keyword information relating to the program may be received, and

when the keyword information coincides with the user's preference information stored in the storage means, the program received by the receiving means may be installed.

The installing means may include:

notifying means for notifying a user when the keyword information coincides with the user's preference information; and

executing means for determining to execute installation of the program based on an instruction by the user.

The changing of the GUI is performed by changing at least one selected from a layout of a menu screen (including addition of a menu item), a button assignment for a remote control, and a decoration of the menu screen.

The keyword information is characteristics information of a remote control,

the preference information is tendency information for a user's operation, and

the program to be installed may be selected based on comparison between the characteristics information and the tendency information.

The tendency information includes at least one of a history of an operation for executing a given 10 function, a type of misoperation caused before execution of the given function, a hand holding the remote control, and information as to whether the remote control is laid in use or held in use.

Characteristics information of a remote control may be received, and

the program to be installed may be selected based on the received characteristics information of the remote control.

The gist of the present invention resides in a GUI changing method for a digital television receiver, including:

receiving a television signal;

receiving a program for changing a GUI;

selectively installing the received program; and

changing the GUI by executing the installed program.

### BRIEF DESCRIPTION OF THE DRAWINGS

FIG. 1 shows a configuration of a digital television system to which a method of changing a graphical user interface according to Embodiment 1 of the present invention is applied;

FIG. 2 is a diagram showing a flow of an operation for changing the graphical user interface;

FIG. 3 is a diagram showing an example of a structure of a user profile;

FIG. 4 is a diagram showing an example of a structure of distributed graphical user interface information;

FIG. 5 is a diagram showing an example of contents of a header for the distributed graphical user interface information;

FIG. 6 is a diagram showing another example of the user profile;

FIG. 7 is a diagram showing an example of an additional operation screen image with a purpose of program advertisement;

FIG. 8 is a diagram showing an example of a screen for notifying a user of reception of software for adding an additional operation screen image;

FIG. 9 shows a configuration of a digital television system to which a method of changing a graphical user interface according to Embodiment 2 of the present invention is applied;

FIG. 10 is a diagram showing a flow of an operation for changing the graphical user interface;

FIG. 11 is a diagram showing an example of a structure of a user profile;

FIG. 12 is a diagram showing an example of a structure of distributed graphical user interface information;

FIG. 13 is a diagram showing an example of contents of a header for the distributed graphical user interface information;

FIG. 14 is a diagram showing another example of the user profile;

FIGS. 15A and 15B are diagrams showing an example of how a menu screen appears before and after changing a menu screen image;

FIG. 16 is a diagram showing an example of a screen for notifying a user of reception of software including decoration information for the menu screen image;

FIG. 17 shows a configuration of a digital television system to which a method of changing a graphical user interface according to Embodiment 3 of the present invention is applied;

FIG. 18 is a diagram showing a flow of an operation for changing the graphical user interface;

FIG. 19 is a diagram showing an example of a structure of a user profile;

FIG. 20 is a diagram showing an example of a structure of distributed remote control information;

FIGS. 21A, 21B and 21C are diagrams showing a flow for calculating a degree of recommendation for the remote control to the user;

FIG. 22 is a diagram showing an example of a screen for notifying the user of a new remote control suitable for the user;

FIG. 23 is a diagram showing an example of a main control device of the remote control;

FIGS. 24A and 24B are diagrams showing an example of how a menu screen appears before and after changing an operation form for the menu screen;

FIG. 25 is a diagram showing an example of a screen for notifying the user of reception of software including a program that provides an operation form corresponding to the remote control;

FIG. 26 shows a configuration of a digital television system to which a method of changing a graphical user interface according to Embodiment 4 of the present invention is applied;

FIGS. 27A, 27B and 27C are diagrams showing a flow for calculating an adaptability of an operation form for a menu screen with respect to a remote control; and

FIG. 28 is a diagram showing an example of a screen for notifying the user of a program that provides an operation form suitable for the remote control.

### DESCRIPTION OF THE PREFERRED EMBODIMENTS

### Embodiment 1

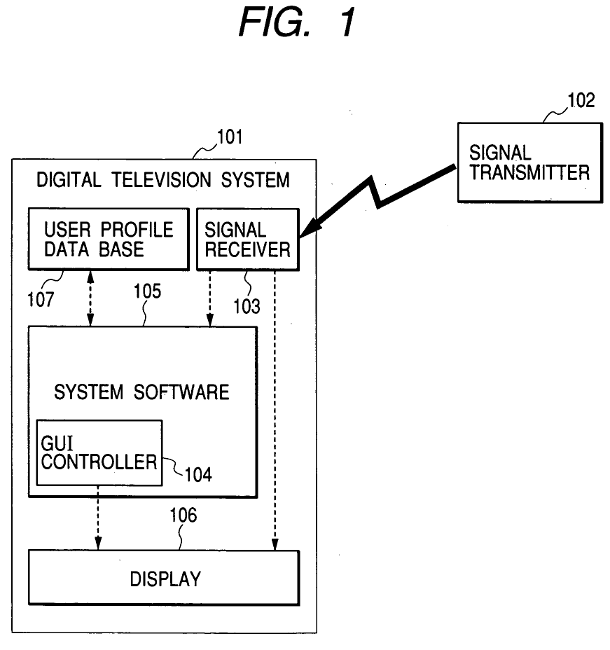

FIG. 1 shows a configuration of a digital television system to which a method of changing a graphical user interface according to Embodiment 1 of the present invention is applied.

In FIG. 1, a digital television system 101 includes a signal receiver 103 for receiving from a signal transmitter 102 a broadcast wave (including television picture signals) broadcast by a program broadcasting side, system software (computer program) 105 including a GUI controller 104 that serves to display a menu and data contents, a display 106 for displaying a picture and a GUI, a user profile database 107 for recording and storing preference information of a user.

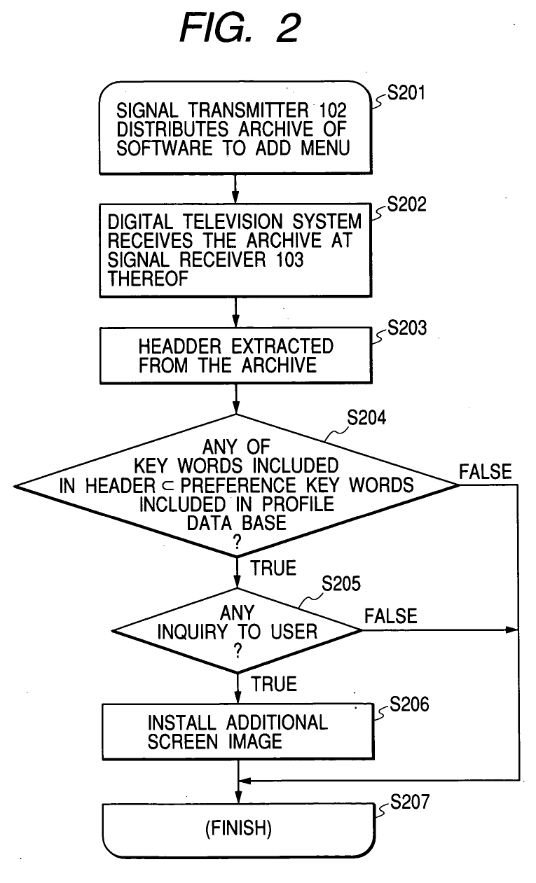

FIG. 2 is a diagram showing a flow of an operation for changing the graphical user interface according to this embodiment.

In step S201, the signal transmitter 102 distributes an archive of software for adding a menu.

In step S202, the digital television system 101 receives the archive at the signal receiver 103.

In step S203, a header is extracted from the received archive.

In step S204, the user profile database 107 is searched through, and it is checked whether any of keywords included in the header belongs to (is included in) preference keywords included in the user profile database 107 or not. If included, the processing advances to step S205, and if not included, the processing advances to step S207. The software (program) for adding a menu is thus selected.

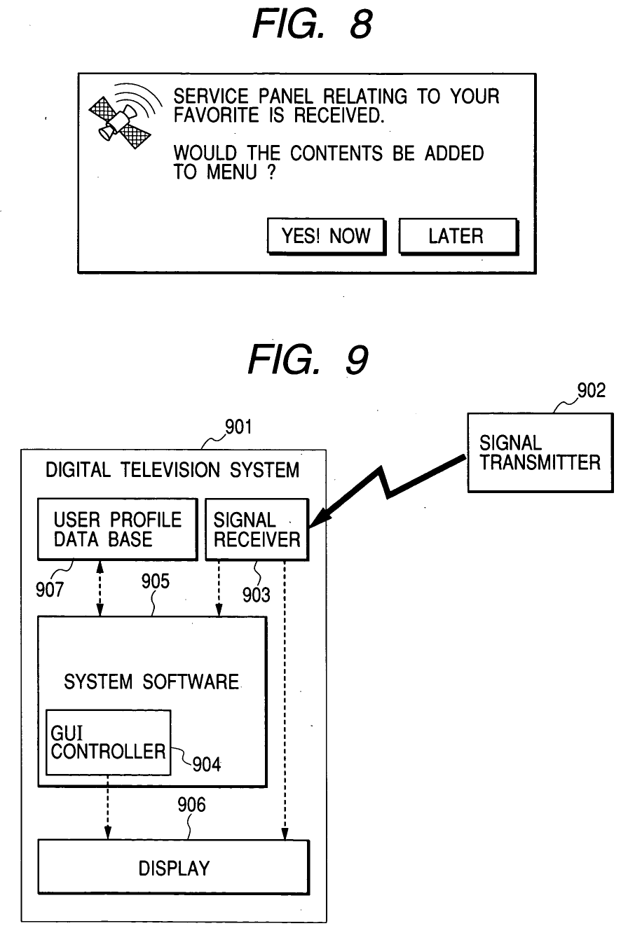

In step S205, an inquiry (FIG. 8) is made to a user. If the user wishes to install an additional screen image, the processing advances to step S206, and if the user does not wish to, the processing advances to step S207.

In step S206, it is determined to execute the installation of the program for adding a menu image, and the installation is executed.

In step S207, the processing finishes.

The digital television system 101 provides the system software 105 with a mechanism for having a user fill in a questionnaire form on his/her preference information at the time of purchasing a product, or a mechanism for learning the user's preference information through a user's operation. Accordingly, the user profile database 107 is created.

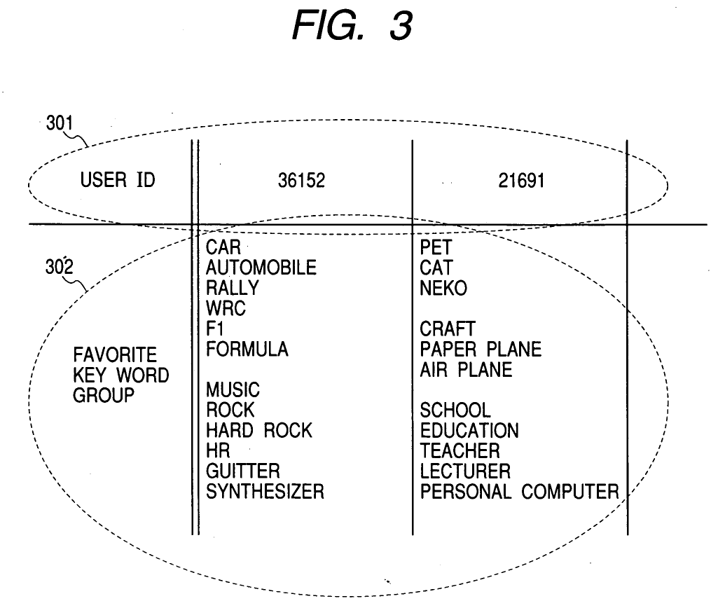

Here, an example structure of the user profile database 107 is shown in FIG. 3.

In the user profile database 107, user identification information (user ID) 301 and user's preference keywords 302 are used to manage user information.

The preference keywords 302 include words serving as keywords based on information of user's “favorites”.

The signal transmitter 102 distributes information (a program) for changing a GUI to the digital television system 101 in each household by superposing the information on the broadcast wave used for a program or a commercial that is being broadcast. The information (program) for changing a GUI is used to display additional screen images for a menu screen of the digital television system 101 for the purpose of providing advertisements and public relations for arbitrary products and planned programs, and an initial operation screen (a portal screen) for relating contents, and other such purposes.

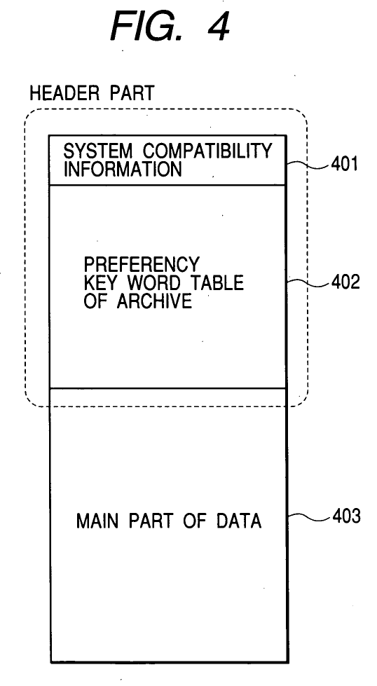

The distributed program has a header part as shown in FIG. 4. The header part includes a system compatibility information 401 and a preference keyword table 402 of archive. The system compatibility information 401 provided in the header part serves to judge an adaptability of the program with respect to the structure of the digital television system 101, determine that the program can be applied to the system, and compare the information in the preference keyword table 402 with the user's preference information. If these information coincide with each other, according to the user's wish, a main part of data (a program) 403 for displaying the additional screen images is installed into the digital television system 101.

The preference keywords 302 included in the user profile database 107 of the digital television system 101 and the preference keyword table 402 included in the distributed information are respectively set by way of the questionnaire or by manual input. In addition, it is possible to (semi)automatically generate the preference keywords 302 by means of keyword extraction from program detail information with reference to a viewing history recorded in a usual state, and the preference keyword table 402 by means of keyword extraction from detail information included in the distributed information.

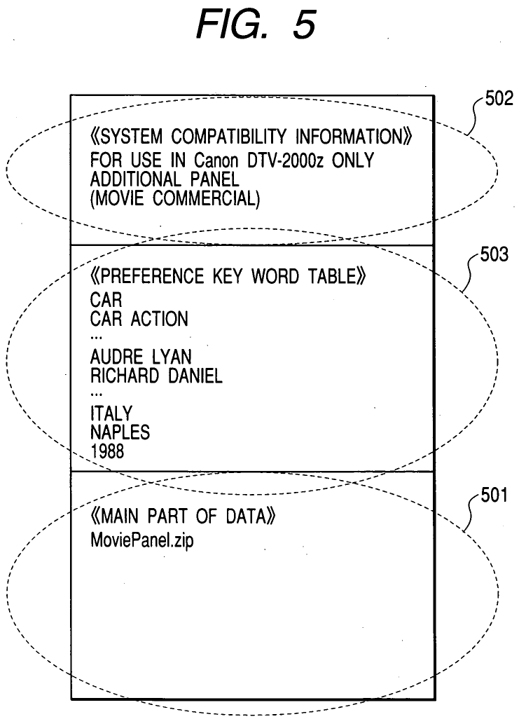

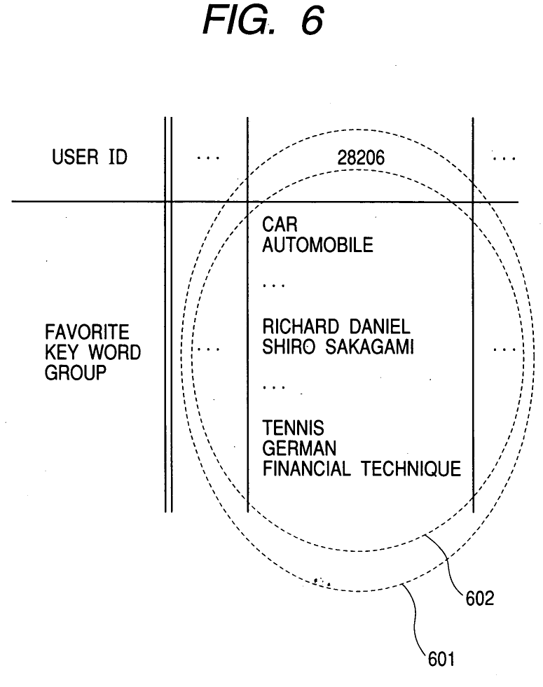

For example, description will be made of a case where the structure of FIG. 5 is adopted for the distributed program consisting of the elements 401 to 403, and the structure of FIG. 6 is adopted for the preference information of a given user included in the user profile database 107 of the digital television system 101.

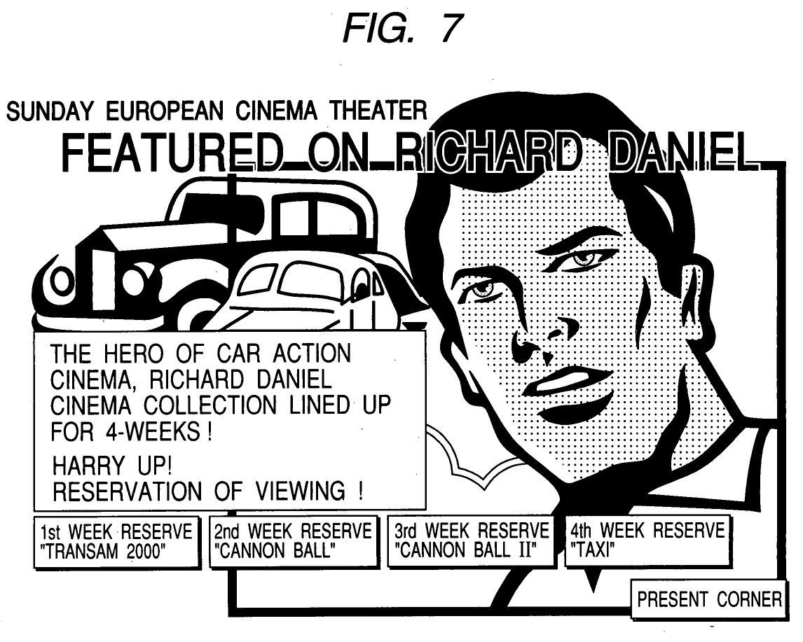

FIG. 5 shows a system compatibility information 502, a preference keyword table 503, and a main part of data 501. The main part of data 501, which serves as a substantial information part of the distributed program, is assumed to be a software updater for providing the user with a menu screen image incorporated with a movie commercial as shown in FIG. 7.

The program of FIG. 5 provides the additional menu screen image relating to the commercial of a new car action movie, and has keywords relating to the contents recorded into the preference keyword table 503 serving as a preference information part.

From the comparison between the keywords in the preference keyword table 503 as the preference information part and a preference keywords 602 in the user profile database part 107 of the digital television system 101, it is understood that there are matched keywords and the user may possibly be interested in the distributed program.

Subsequently, a screen is displayed as shown in FIG. 8 to inquire the user's judgment as to whether the user will use the distributed program or not. In the case where the user will use the distributed program, the screen image shown in FIG. 7 is added to the menu screen, that is, the GUI is changed.

According to the above description, it is possible for the user to easily add a menu screen image for utilizing services by being notified of only the image that suits the user's preference selected from among the distributed additional menu screen images.

As to the use of user information, description is made in Japanese Patent Application Laid-open No. 2002-297657.

### Embodiment 2

FIG. 9 shows a configuration of a digital television system to which a method of changing a graphical user interface according to Embodiment 2 of the present invention is applied.

In FIG. 9, a digital television system 901 includes a signal receiver 903 for receiving from a signal transmitter 902 a broadcast wave broadcast by a program broadcasting side, system software 905 including a GUI controller 904 that serves to display a menu and data contents, a display 906 for displaying a picture and a GUI, a user profile database 907 for recording and storing preference information of a user.

FIG. 10 is a diagram showing a flow of an operation for changing the graphical user interface according to this embodiment.

In step S1001, the signal transmitter 902 distributes an archive of software for decorating a menu.

In step S1002, the digital television system 901 receives the archive at the signal receiver 903.

In step S1003, a header is extracted from the received archive.

In step S1004, the user profile database 907 is searched through, and it is checked whether any of keywords included in the header belongs to (is included in) preference keywords included in the user profile database 907 or not. If included, the processing advances to step S1005, and if not included, the processing advances to step S1007.

In step S1005, an inquiry (FIG. 16) is made to a user. If the user wishes to install decoration data, the processing advances to step S1006, and if the user does not wish to, the processing advances to step S1007. Accordingly, selective installation can be performed.

In step S1006, the installation of the decoration data is performed as a program for changing the GUI.

In step S1007, the processing finishes.

The digital television system 901 provides the system software 905 with a mechanism for having a user fill in a questionnaire form on his/her preference information at the time of purchasing a product, or a mechanism for learning the user's preference information through a user's operation. Accordingly, the user profile database 907 is created.

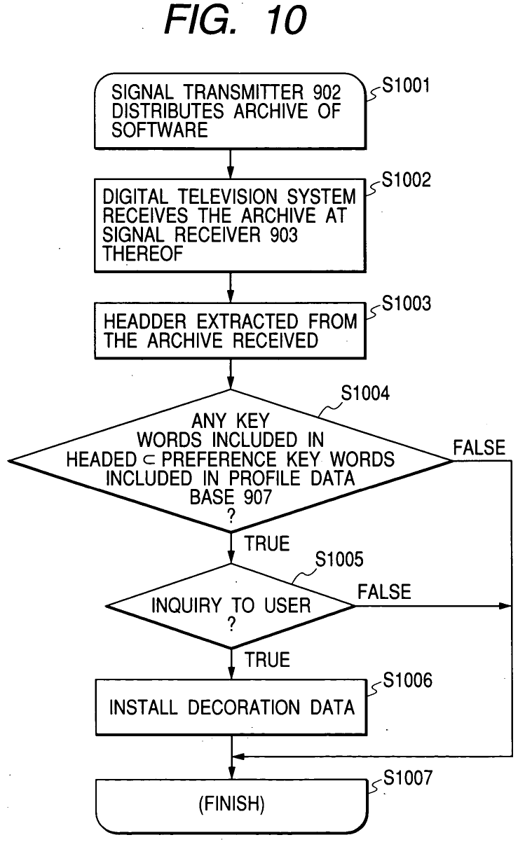

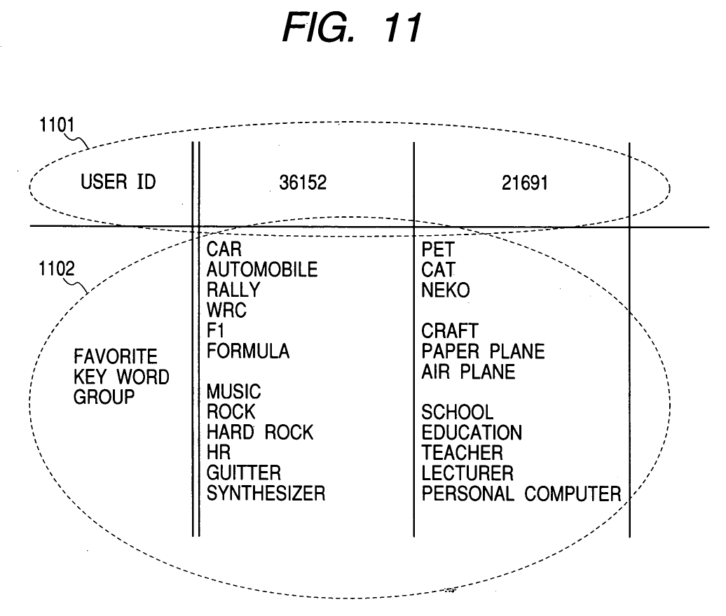

Here, an example structure of the user profile database 907 is shown in FIG. 11.

In the user profile database 907, user identification information (user ID) 1101 and user's preference keywords 1102 are used to manage user information.

The preference keywords 1102 include words serving as keywords based on information of user's “favorites”.

The signal transmitter 902 distributes information (a program) to the digital television system 901 in each household by superposing the information on the broadcast wave used for a program or a commercial that is being broadcast. The information (program) is used to decorate components (buttons and panels) of a menu screen image of the digital television system 901 for the purpose of enhancing the user's recognition of the services or increasing the user's sense of attachment by use of advertisements and public relations for arbitrary products and planned programs, or characters etc. symbolizing the services used as in character goods.

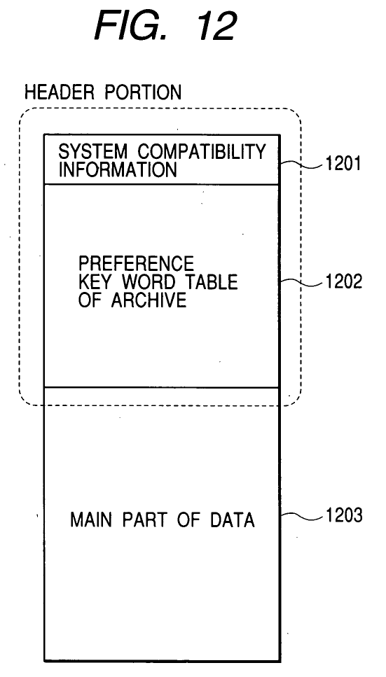

The distributed program has a header part as shown in FIG. 12. The header part includes a system compatibility information 1201 and a preference keyword table 1202 of archive. The system compatibility information 1201 provided in the header part serves to judge an adaptability of the program with respect to the structure of the digital television system 901, determine that the program can be applied to the system, and then compare the information in the preference keyword table 1202 with the user's preference information. If these information coincide with each other, according to the user's wish, a main part of data (a program) 1203 for decorating the screen components is installed into the digital television system 901.

The preference keywords 1102 included in the user profile database 907 of the digital television system 901 and the preference keyword table 1202 included in the distributed program are respectively set by way of the questionnaire or by manual input. In addition, it is possible to (semi)automatically generate the preference keywords 1102 by means of keyword extraction from program detail information with reference to a viewing history recorded in a usual state, and the preference keyword table 1202 by means of keyword extraction from detail information included in the distributed information.

FIG. 13 shows system compatibility information 1302, a preference keyword table 1303, and a main part of data 1301. For example, description will be made of a case where the structure of FIG. 13 is adopted for the distributed program consisting of the elements 1201 to 1203, and the structure of FIG. 14 is adopted for the preference information of a given user included in the user profile database 907 of the digital television system 901.

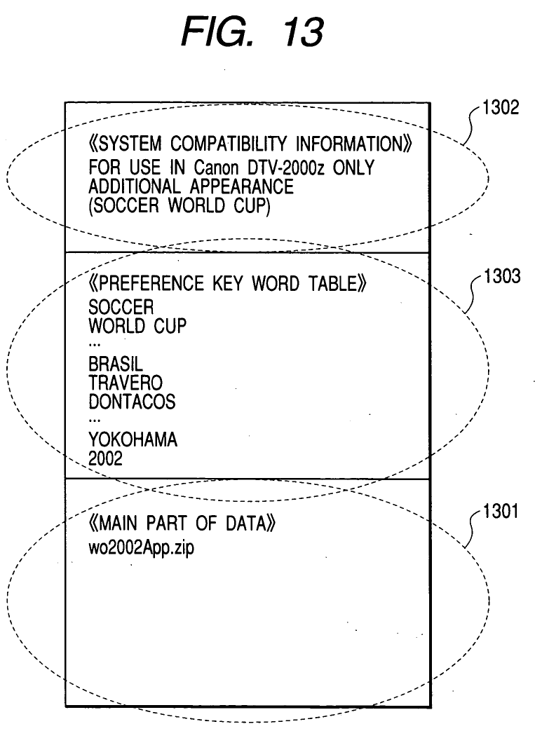

The main part of data 1301, which serves as a substantial information part of the distributed program, is assumed to provide data and program for changing components as of FIG. 15A into components as of FIG. 15B.

The menu screen images of FIGS. 15A and 15B are structured by sets of menu items 1501a and 1501b and menu focuses 1502a and 1502b, respectively. The menu screen image of FIG. 15B is added with a menu selection mascot. 1503b that exhibits a visual effect when moving the menu focus 1502b.

The program of FIG. 13 provides a screen decoration program relating to the soccer world cup, and the keywords relating to its contents are recorded in the preference keyword table 1303.

From the comparison between the keywords in the preference keyword table 1303 and preference keywords 1402 in the user profile database part 907 of the digital television system 901, it is understood that there are matched keywords and the user may possibly be interested in the distributed program.

Subsequently, a screen is displayed as shown in FIG. 16 to inquire the user's judgment as to whether the user will use the distributed program or not. In the case where the user will use the distributed program, the screen image (GUI) is changed as shown in FIG. 15B.

According to the above description, it is possible to provide a user with a menu screen image suitable for his/her preference by notifying the user of only the function that suits the user's preference selected from among the distributed additional functions.

As to the use of keywords, description is made in Japanese Patent Application Laid-open No. 2002-300483.

### Embodiment 3

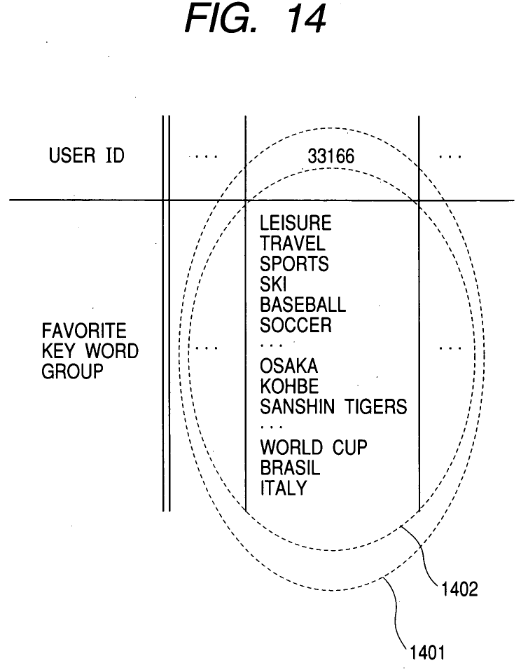

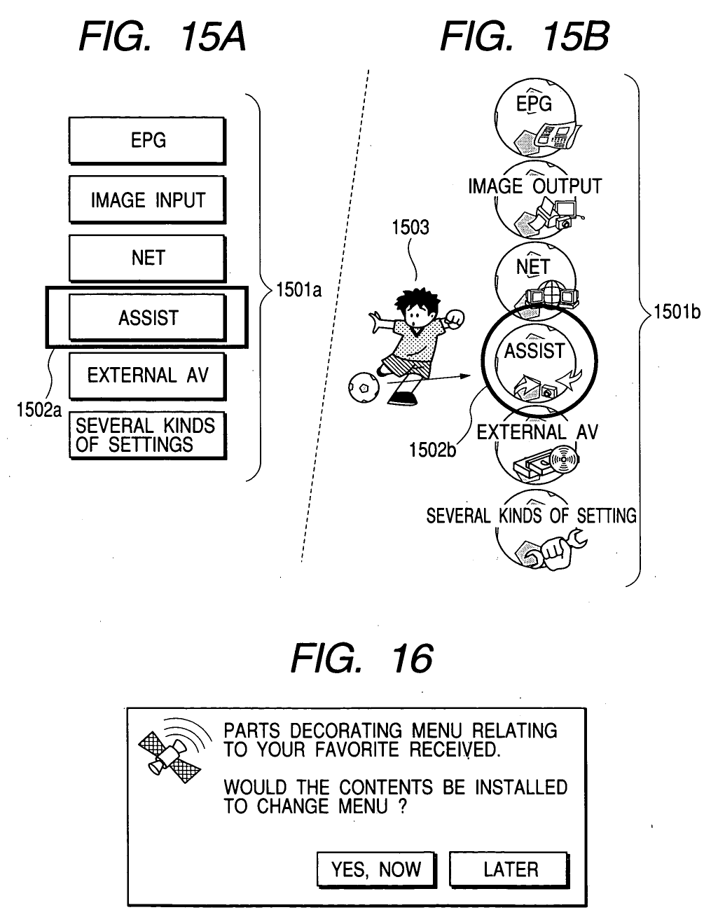

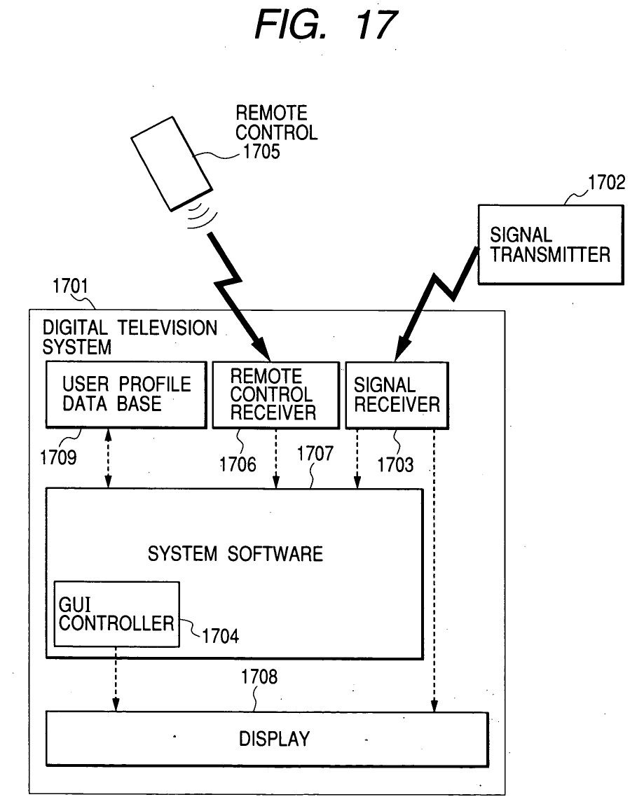

FIG. 17 shows a configuration of a digital television system to which a method of changing a graphical user interface according to Embodiment 3 of the present invention is applied.

In FIG. 17, a digital television system 1701 includes a signal receiver 1703 for receiving from a signal transmitter 1702 a broadcast wave broadcast by a program broadcasting side, system software 1707 including a GUI controller 1704 that serves to display a menu and data contents, a remote control receiver 1706 for receiving signals from a remote control 1705, a display 1708 for displaying a picture and a GUI, a user profile database 1709 for recording and storing preference information and characteristics information of a user.

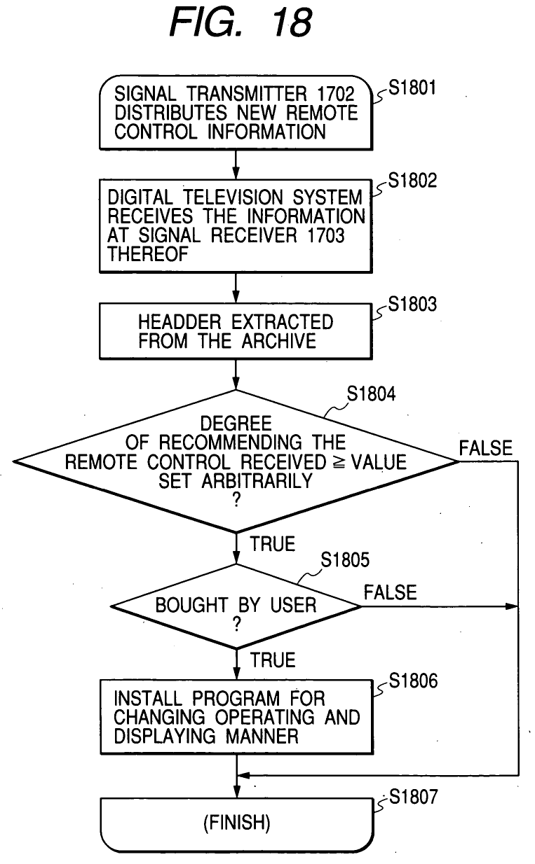

FIG. 18 is a diagram showing a flow of an operation for changing the graphical user interface according to this embodiment.

In step S1801, the signal transmitter 1702 distributes a new remote control information.

In step S1802, the digital television system 1701 receives the new remote control information at the signal receiver 1703.

In step S1803, a header is extracted from the received archive.

In step S1804, it is checked whether a degree of recommendation for the remote control is equal to or higher than a value set arbitrarily or not. If equal to or higher than the set value, the processing advances to step S1805, and if lower than the set value, the processing advances to step S1807. Accordingly, selective installation can be performed.

In step S1805, if there is a user's instruction of purchase and the user wishes to install a program for changing an operating and displaying manner, the processing advances to step S1806, and if the user does not wish to, the processing advances to step S1807.

In step S1806, it is determined to execute the installation of the program for changing an operating and displaying manner, and the installation is executed.

In step S1807, the processing finishes.

The remote control 1705 can be selected by the user from among a plurality of the remote controls 1705 that satisfy predetermined criteria (such as a transmission method for signals and a type of button required minimally). The remote control receiver 1706 of the digital television system 1701 is assumed to be capable of receiving signals from any remote control 1705 that satisfies the criteria.

It is also assumed that the user can selectively use the remote control having an operation device that is his/her “favorite” one or “suitable for his/her physical conditions”.

The digital television system 1701 provides the system software 1707 with a mechanism for having a user fill in a questionnaire form on his/her preference information and characteristics information at the time of purchasing a product, or a mechanism for learning the user's preference information and characteristics information through a user's operation. Accordingly, the user profile database 1709 is created.

Here, an example structure of the user profile database 1709 is shown in FIG. 19.

In the user profile database 1709, user identification information (user ID) 1901, user's preference keywords 1902, and user's characteristics information parameter part 1903 are used to manage user information.

The preference keywords 1902 include words serving as keywords based on information of user's “favorites”.

The user's natures are stored in the user's characteristics information parameter part 1903. For example, a user's whip hand, the presence or absence of a physical disability, basic operation using a remote control (whether to use a ten-key numeric pad or keys labeled as “+”, “.”, and “−”), the number of redos for an operation, etc. are recorded. The user's characteristics information (tendency information for a user's operation) 1903 includes at least one of a history of an operation for executing a given function, a type of misoperation caused before the execution, a hand holding a remote control, and information as to whether the remote control is laid or held in use.

The signal transmitter 1702 is used by a manufacturer or the like manufacturing a remote control that can be used in the digital television system 1701 to distribute advertisement information of the manufactured remote control to the digital television system 1701 in each household by superposing the advertisement information on the broadcast wave.

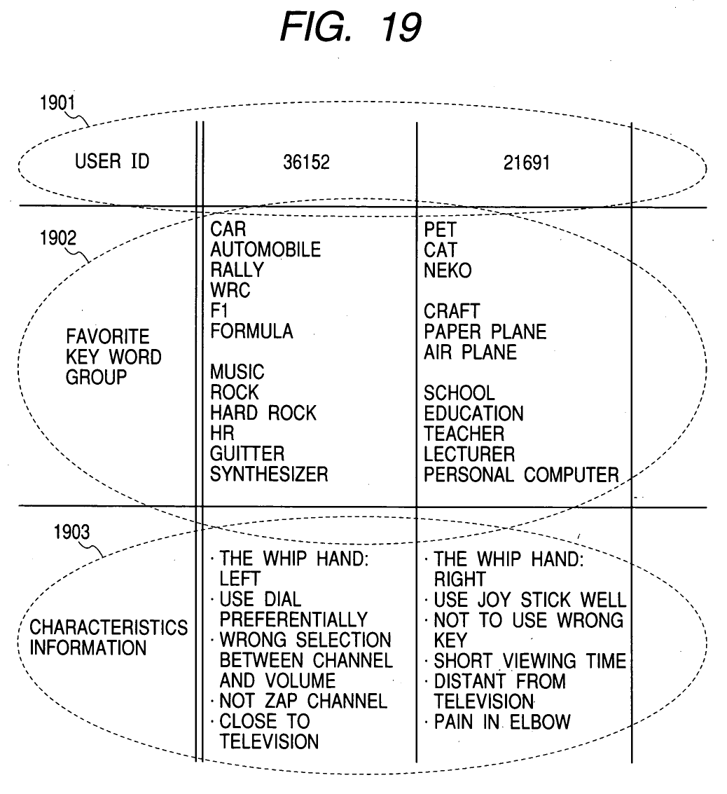

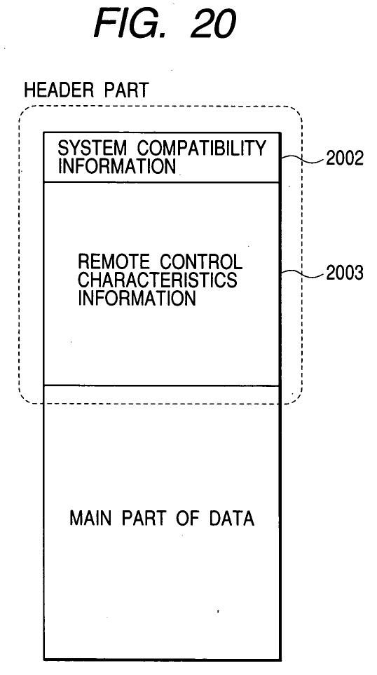

The distributed advertisement information has a header part and a main part of data as shown in the structure of FIG. 20. The header part includes system compatibility information 2002 and remote control characteristics information 2003. The system compatibility information 2002 included in the header part is used to judge the adaptability of the remote control with respect to the digital television system 1701, and check whether the remote control can be applied to the system.

Then, the degree of recommendation for the remote control to the user is determined based on the remote control characteristics information 2003 notified of in the distributed advertisement information and the user's characteristics information parameter part 1903 stored in the user profile database 1709 of the digital television system 1701.

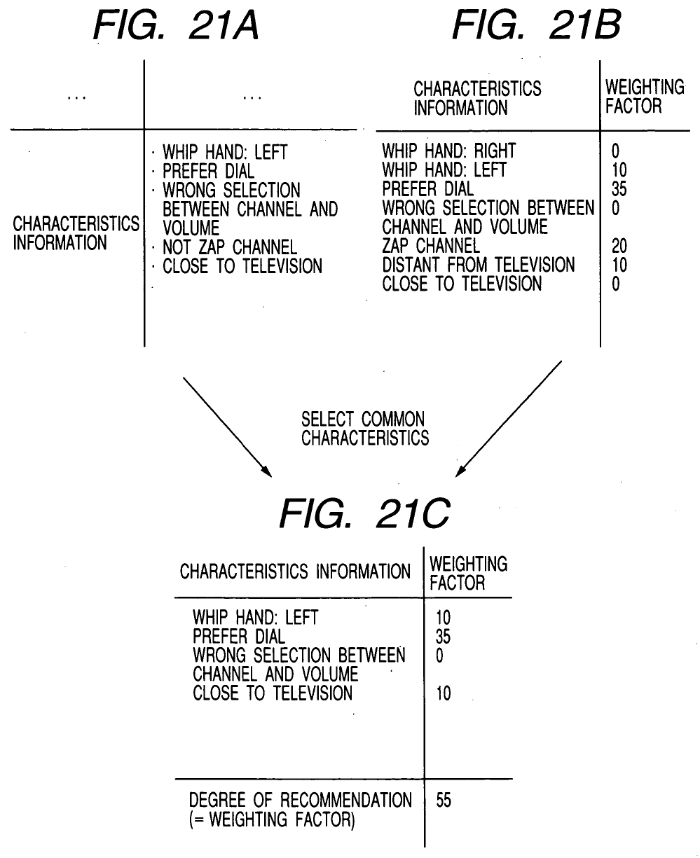

For example, FIGS. 21A to 21C shows a flow for obtaining the degree of recommendation. In the case of a user's profile shown in FIG. 21A, common characteristics with respect to the transmitted characteristics information of the remote control of FIG. 21B are selected. As shown in FIG. 21C, weighting factors (which have been assigned to the characteristics information of the remote control) of the common characteristics are summed up to set the resultant value as the degree of recommendation for the remote control.

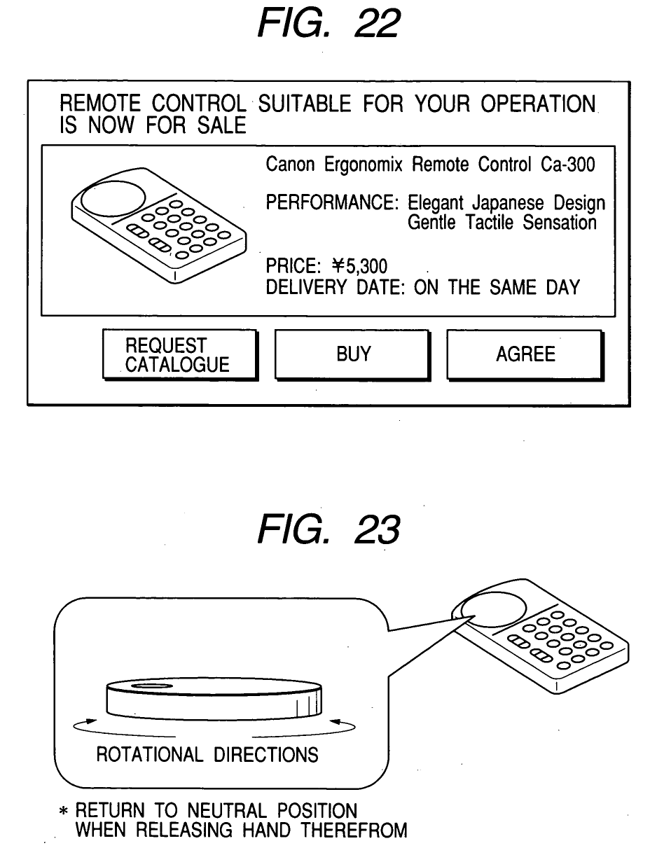

The degree of recommendation for the remote control is thus calculated according to the flow of FIGS. 21A to 21C, and the user is notified of the remote control with the degree of recommendation exceeding a predetermined value as shown in FIG. 22.

If the user notified of the information shown in FIG. 22 purchases the remote control, driverware and information (a program) for changing a graphical user interface are distributed.

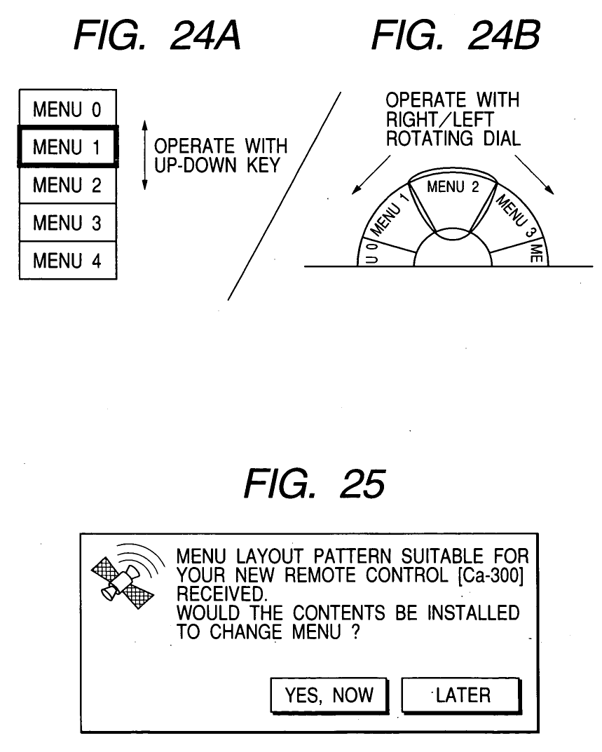

The program for changing a graphical user interface which is distributed at this time indicates a program for, in the case where the purchased remote control is, for example, equipped with a bidirectional shuttle device shown in FIG. 23, changing a menu image shown in FIG. 24A into a menu image shown in FIG. 24B.

When the reception of the distributed program finishes, such notification as shown in FIG. 25 is made to have the user judge whether to adopt the change into a graphical user interface pattern (layout or button assignment for the remote control) suitable for the remote control in use. If the user wishes, the program for changing an operating and displaying manner is installed to the digital television system 1701.

According to the above description, the user can receive recommendation of a remote control suitable for the user, and the layout or the button assignment for the remote control can be variously set based on the forms of the remote controls.

### Embodiment 4

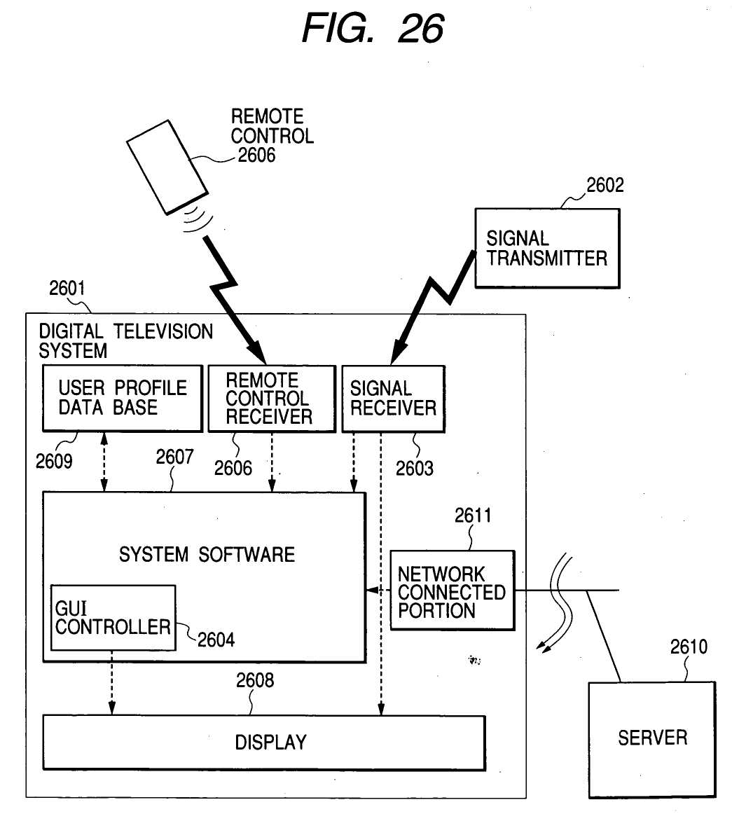

According to Embodiment 4 of the present invention, as shown in FIG. 26, a network connected portion 2611 for connection with a network and a server 2610 existing in the network are added to the system of FIG. 17 according to Embodiment 3.

The server 2610 constantly accumulates programs for a graphical user interface (layout or button assignment for the remote control) which is transmitted from the signal transmitter 2602.

Although the notification of another remote control may not be received in Embodiment 3, in the case where the number of misoperations for a given operation exceeds a predetermined number, or in the case of having the characteristics information based on which it is judged as being desirable to change the graphical user interface (the judgment is performed by, for example, an agent function), the following process is performed. That is, the digital television side searches through the server 2610 based on the characteristics information, and automatically downloads information (a program) for changing the graphical user interface.

The server 2610 accumulates programs for changing the graphical user interface, and is accompanied with characteristics information indicating a compatibility with an arbitrary remote control.

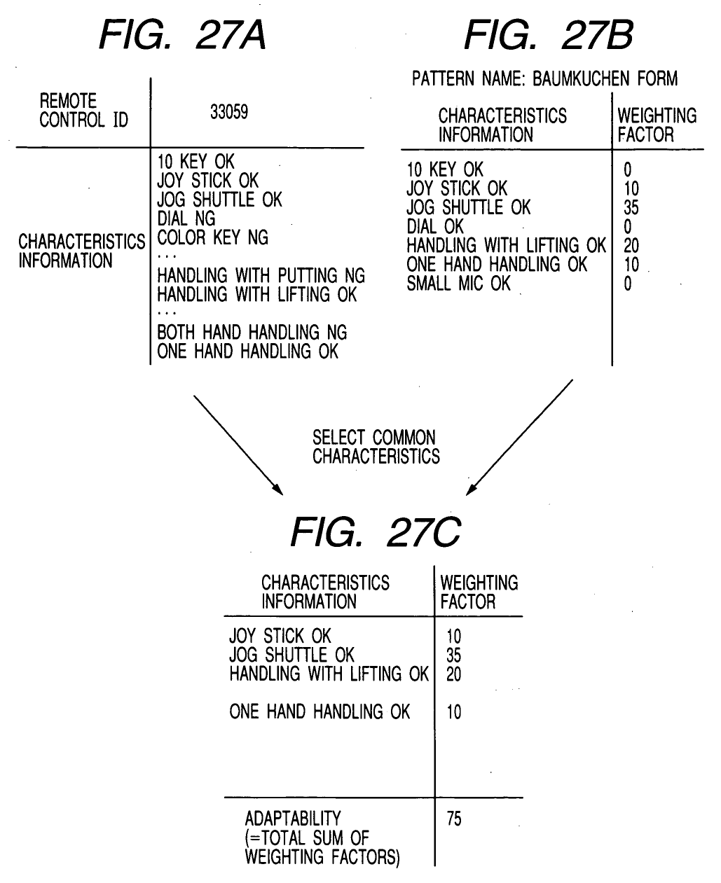

The digital television system 2601 transmits the information on a remote control 2605 currently in use to the server 2610. The server 2610 that has received the information on the remote control 2605 compares the characteristics information accompanying graphical user interface patterns with the received information, and calculates the adaptability according to the procedure of FIGS. 27A to 27C.

In the case where the characteristics information of a given remote control is structured as shown in FIG. 27A, the characteristics information is compared with the characteristics information of a graphical user interface pattern of FIG. 27B, which accompanies an archive of the programs for changing a graphical user interface pattern stored in the server, to select the common characteristics. As shown in FIG. 27C, the weighting factors (which have been assigned to the characteristics information of the graphical user interface pattern) of the common characteristics are summed up to set the resultant value as the adaptability.

If the calculated adaptability exceeds a predetermined value, the program for changing for the graphical user interface with the adaptability is transmitted to the digital television system 2601.

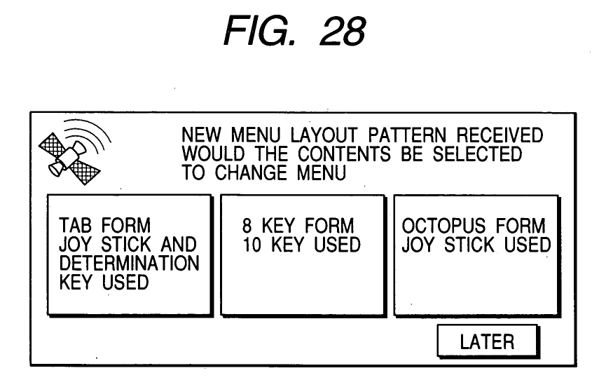

In the digital television system 2601 that has been received the information for changing the graphical user interface, such notification as shown in FIG. 28 is made to have the user judge whether to adopt the change into another graphical user interface pattern (layout or button assignment for the remote control) suitable for the remote control in use. If the user wishes to adopt the change, the digital television system 2601 selectively installs the received program.

According to the above description, the user can set another operation form (layout or button assignment for the remote control) suitable for the remote control currently in use.

As described above, the digital television system according to Embodiment 1 includes the display means for organizing the menu screen of the digital television for display, the receiving means for receiving a program for adding an additional menu item and additional menu item group to the menu screen image, the accumulating means for accumulating the user's preference information, the notifying means for notifying the user of only the program suitable for the user's preference information based on the relating keywords accompanying the distributed program, and the executing means for executing the application of the program. Thus, the digital television system provides the additional operation screen image.

According to Embodiment 1, it is possible for a user to easily add a menu screen image for utilizing services by being notified of only the function that suits the user's preference selected from among the distributed additional functions.

The digital television system according to Embodiment 2 includes the display means for organizing the menu screen of the digital television for display, the receiving means for receiving a program for decorating the menu screen according to a given theme, the accumulating means for accumulating the user's preference information, the notifying means for notifying the user of only the program suitable for the user's preference information based on the relating keywords accompanying the distributed program, and the executing means for executing the application of the program. Thus, the digital television system decorates the operation screen for the user.

According to Embodiment 2, it is possible to provide a user with a menu screen image suitable for his/her preference by notifying the user of only the function that suits the user's preference selected from among the distributed additional functions.

The digital television system according to Embodiment 3 includes the display means for organizing the menu screen of the digital television for display, the remote control for operating the menu screen, the receiving means for receiving a command (indicating which key is depressed or the like) and information (manufacturer ID and equipment ID) unique to the remote control which are transmitted to the digital television by the operation of the remote control, the receiving means for receiving a program for changing the layout of the menu screen and the button assignment for the remote control for operation, and the accumulating means for accumulating the tendency information for the user's operation (such as the history of the operation for executing a given function, the type of misoperation caused before execution of the given function, the hand holding the remote control, and information as to whether the remote control is laid in use or held in use). The digital television system according to Embodiment 3 further includes the calculating means for calculating the characteristics information of the remote control included in the specification information of the distributed new remote control and the degree of recommendation for the remote control from the tendency information for the user's operation, the notifying means for notifying the user of the remote control whose degree of recommendation exceeds a predetermined value, the receiving means for receiving the program for providing the layout of a menu screen and the button assignment for the remote control which are suitable for the operation using the remote control, and the executing means for executing the application of the program. Thus, the layout of the menu screen and the button assignment for the remote control are changed for the user.

According to Embodiment 3, the user can receive the recommendation of the remote control according to the user's operation environment, and the operation forms can be variously set based on the forms of the remote controls.

The digital television system according to Embodiment 4 is structured by adding to the digital television system according to Embodiment 3 the network connecting means for connection with a network and the accumulating means for accumulating the programs for changing the layout of the menu screen and the button assignment for the remote control. From among the programs for changing the layout of the menu screen and the button assignment for the remote control, the user is provided with the program with the adaptability exceeding a predetermined value. The adaptability is calculated from the characteristics information of the remote control currently in use and the characteristics information of the graphical user interface to be attained by the program which accompanies the program for changing the layout of the menu screen and the button assignment pattern for the remote control.

According to Embodiment 4, the user can easily set another operation form suitable for the remote control currently in use.

Embodiment 4 can be realized by causing a computer (digital television system etc.) to execute the program. Further, as Embodiment 4, it is possible to adopt program providing means for providing a program to the computer, for example, a recording medium such as a CD-ROM that records the program therein or a transmission medium such as the Internet that transmits the program therethrough. The program, the recording medium, and the transmission medium are included in the scope of the present invention. As the recording medium, there can be used, for example, a flexible disk, a hard disk, an optical disk, a magneto-optical disk, a CD-ROM, a magnetic tape, a nonvolatile memory card, and a ROM.

Note that the above-mentioned embodiments have been respectively presented merely as specific examples for implementing the present invention, and the technical scope of the present invention should not be construed as being limited those embodiments. That is, the present invention can be implemented in various forms without departing from the technical spirit or essential characteristics thereof.

What is claimed is:

1. A digital television receiver, comprising:
a television picture signal;
receiving means for receiving a program for changing a GUI;
installing means for selectively installing the program received by the receiving means; and
changing means for executing the installed program to change the GUI.

2. A digital television receiver according to claim 1, wherein the installing means determines whether to install the program received by the receiving means based on an instruction by a user.

3. A digital television receiver according to claim 1, further comprising display means for displaying a menu screen.

4. A digital television receiver according to claim 1, further comprising storage means for storing user's preference information, wherein:
keyword information relating to the program is received; and
when the keyword information coincides with the user's preference information stored in the storage means, the program received by the receiving means is installed.

5. A digital television receiver according to claim 4, wherein the installing means includes:
notifying means for notifying a user when the keyword information coincides with the user's preference information; and
executing means for determining to execute installation of the program based on an instruction by the user.

6. A digital television receiver according to claim 1, wherein the changing of the GUI is performed by changing at least one selected from a layout of a menu screen, a button assignment for a remote control, and a decoration of the menu screen.

7. A digital television receiver according to claim 4, wherein:
the keyword information is characteristics information of a remote control;
the preference information is tendency information for a user's operation; and
the program to be installed is selected based on comparison between the characteristics information and the tendency information.

8. A digital television receiver according to claim 7, wherein the tendency information includes at least one of a history of an operation for executing a given function, a type of misoperation caused before execution of the given function, a hand holding the remote control, and information as to whether the remote control is laid in use or held in use.

9. A digital television receiver according to claim 1, wherein:
characteristics information of a remote control is received; and
the program to be installed is selected based on the received characteristics information of the remote control.

10. A GUI changing method for a digital television receiver, comprising:
receiving a television signal;
receiving a program for changing a GUI;
selectively installing the received program; and
changing the GUI by executing the installed program.
